(19) United States
(12) Patent Application Publication
(10) Pub. No.: US 2026/0341774 A1
(43) Pub. Date: Oct. 29, 2026

(54) ELECTRODE ASSEMBLY AND SECONDARY BATTERY INCLUDING THE SAME, MANUFACTURING APPARATUS AND METHOD FOR THE SAME

(71) Applicant: SK On Co., Ltd., Seoul (KR)

(72) Inventors: Moon Hyung JUNG, Daejeon (KR); Won Je OH, Daejeon (KR); Seung Won CHOI, Daejeon (KR); Jae Gyu BYUN, Daejeon (KR)

(21) Appl. No.: 19/661,597

(22) Filed: Apr. 28, 2026

(30) Foreign Application Priority Data
Apr. 28, 2025 (KR) 10-2025-0055073

(51) Int. Cl. H01M 10/04

(52) U.S. Cl. CPC H01M 10/0431; H01M 10/0409

(57) ABSTRACT

An electrode assembly is disclosed. In some implementations, the electrode assembly includes: a first electrode plate wound in a winding direction and including a first non-coated region in which a first electrode active material is not coated; a second electrode plate wound in the winding direction and including a second non-coated region in which a second electrode active material is not coated; and a separator disposed between the first electrode plate and the second electrode plate, wherein at least one of the first non-coated region or the second non-coated region includes a plurality of connection portions folded along folding lines.

### CROSS-REFERENCE TO RELATED APPLICATIONS

This application claims benefit of priority to Korean Patent Application No. 10-2025-0055073 filed on Apr. 28, 2025 in the Korean Intellectual Property Office, the disclosure of which is incorporated herein by reference in its entirety.

### TECHNICAL FIELD

The disclosure and implementations disclosed in this patent document generally relate to an electrode assembly and a secondary battery including the same, a manufacturing apparatus and method for the same.

A secondary battery may be rechargeable and dischargeable unlike a primary battery, thereby providing convenience, and is thus in the spotlight as a power source for various mobile devices, electric vehicles, or the like. The secondary battery may be rechargeable and dischargeable unlike the primary battery, and may thus be applied to devices within various fields such as a digital camera, a mobile phone, a laptop computer, a hybrid vehicle, an electric vehicle, and an energy storage system (ESS).

The secondary battery may include a battery cell in which an electrode assembly is accommodated in a case, the electrode assembly being formed by stacking a cathode plate, an anode plate, and a separator or being wound in a roll shape. A plurality of battery cells may be stacked in a predetermined direction and accommodated in a battery module or a battery pack.

Meanwhile, in a cylindrical-type battery cell in which a case has a cylindrical shape, an electrode assembly may be accommodated in the case after stacking a cathode plate, an anode plate, and a separator and then winding the electrode assembly.

A non-coated region of the cathode plate and a non-coated region of the anode plate may be notched at a predetermined interval to form a plurality of flags, and the plurality of flags may be connected to a current collector in a state in which the plurality of flags are bent toward the center.

### SUMMARY

The present disclosure may be implemented in some embodiments to provide an electrode assembly in which a flag is formed without notching a non-coated region.

The present disclosure may be implemented in some embodiments to provide an electrode assembly having improved quality.

The present disclosure may be implemented in some embodiments to provide an electrode assembly having a reduced manufacturing cost.

An electrode assembly and manufacturing apparatus and method for the same according to the present disclosure may be widely applied in green technology fields such as an electric vehicle, a battery charging station, solar power generation using a battery, or wind power generation using a battery. In addition, the electrode assembly and the manufacturing apparatus and method for the same according to the present disclosure may be used in an eco-friendly electric vehicle, a hybrid vehicle, or the like for suppressing air pollution and greenhouse gas emission to prevent climate change.

In some embodiments of the present disclosure, provided is an electrode assembly including: a first electrode plate wound in a winding direction and including a first non-coated region in which a first electrode active material is not coated; a second electrode plate wound in the winding direction and including a second non-coated region in which a second electrode active material is not coated; and a separator disposed between the first electrode plate and the second electrode plate, wherein at least one of the first non-coated region or the second non-coated region includes a plurality of connection portions folded along folding lines.

The folding lines may allow the plurality of connection portions to be folded into a trapezoidal shape and may form a folding portion disposed between the plurality of connection portions.

The folding lines may include a first folding line and a second folding line having a predetermined angle therebetween, and the first folding line and the second folding line may form a folding portion disposed between the plurality of connection portions.

The plurality of connection portions may be folded to overlap at least a portion thereof in the winding direction.

The first folding line and the second folding line may be folded in directions opposite to each other.

The plurality of connection portions may be folded toward one side based on the first folding line and toward the other side based on the second folding line.

Each of the plurality of connection portions may have a width that increases from a starting portion toward an ending portion.

A base angle of the folding portion disposed between the plurality of connection portions may be constant from the starting portion toward the ending portion.

Each of the plurality of connection portions may have a constant width from a starting portion toward an ending portion.

A base angle of the folding portion disposed between the plurality of connection portions may decrease from the starting portion toward the ending portion.

In some embodiments of the present disclosure, provided is a manufacturing apparatus for a secondary battery, the apparatus including: a pair of folding rollers rotating about a rotation axis, wherein the pair of folding rollers include a plurality of teeth portions formed on an outer circumferential surface and form folding lines to allow a non-coated region of the electrode plate to be folded while rotating with the electrode plate interposed therebetween.

The folding rollers may allow the rotation axis to form predetermined angles with respect to a horizontal line of the electrode plate, and the folding rollers may include the rotation axis having a changeable angle to change the predetermined angles.

The manufacturing apparatus may further include a folding guide guiding the non-coated regions to be folded along the folding lines.

In some embodiments of the present disclosure, provided is a manufacturing method for a secondary battery, the manufacturing method including: preparing an electrode plate including non-coated regions; patterning the non-coated regions to form folding lines; and winding the electrode plate in a winding direction, wherein the winding further includes guiding the non-coated regions to be folded along the folding lines using a folding guide.

Although the solutions according to the present disclosure are described above, these solutions are merely exemplary, and it should be understood that even if other configurations not described herein are added thereto, such configurations fall within the scope of the present disclosure.

### BRIEF DESCRIPTION OF DRAWINGS

Certain aspects, features, and advantages of the present disclosure are illustrated by the following detailed description with reference to the accompanying drawings.

FIG. 1 is a view illustrating a portion of a conventional electrode plate.

FIG. 2 is a view illustrating a secondary battery according to an embodiment.

FIG. 3 is an exploded view illustrating the secondary battery according to an embodiment.

FIG. 4 is a view schematically illustrating an electrode assembly according to an embodiment.

FIG. 5 is a view schematically illustrating an electrode plate according to an embodiment.

FIG. 6 is a view illustrating a non-coated region illustrated in FIG. 5.

FIG. 7 is a view schematically illustrating an electrode plate according to another embodiment.

FIG. 8 is a view illustrating a non-coated region illustrated in FIG. 7.

FIG. 9 is a view illustrating a first embodiment of the non-coated region.

FIG. 10 is a view illustrating a second embodiment of the non-coated region.

FIG. 11 is a view illustrating a third embodiment of the non-coated region.

FIG. 12 is a schematic view illustrating a manufacturing apparatus according to an embodiment.

FIG. 13 is a view illustrating a roller portion according to an embodiment.

FIG. 14 is a view illustrating a manufacturing process using the roller portion.

FIG. 15 is a view illustrating an operation example of the roller portion.

FIG. 16 is a view illustrating a manufacturing process using a folding guide.

FIG. 17 is a flowchart illustrating a manufacturing method according to an embodiment.

### DETAILED DESCRIPTION

Features of the present disclosure disclosed in this patent document are described by example embodiments with reference to the accompanying drawings.

The present disclosure may be implemented in some embodiments to provide an electrode assembly and a secondary battery including the same, manufacturing apparatus and method for the same.

Hereinafter, the present disclosure is described in detail with reference to the drawings.

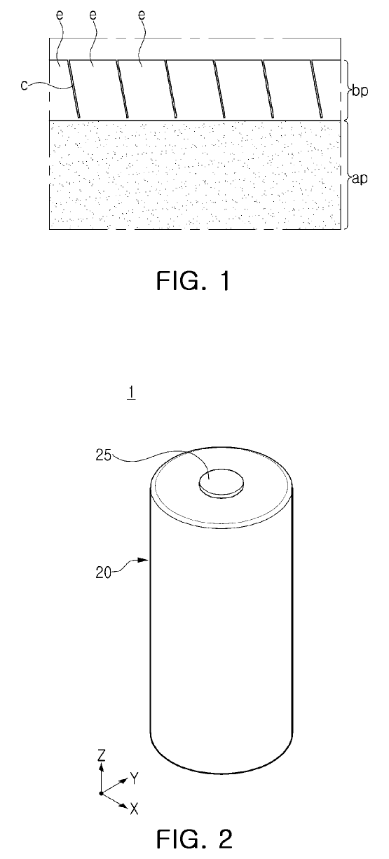

FIG. 1 is a view illustrating a portion of a conventional electrode plate.

Referring to FIG. 1, the conventional electrode plate may include a coating portion (ap) in which an electrode active material is coated on a current collector and a non-coated region (bp) in which the electrode active material is not coated on the current collector. In addition, notching (c) may be performed on the non-coated region (bp) at a predetermined interval to form a plurality of connection portions (e). However, in the conventional electrode plate, foreign substances such as conductive particles may occur during the notching process, thereby reducing quality of the conventional electrode plate. According to an embodiment, a configuration corresponding to the plurality of connection portions (e) may be formed without performing the notching (c) or by performing the notching (c) on only a minimal portion. Hereinafter, the present disclosure is described with reference to the drawings.

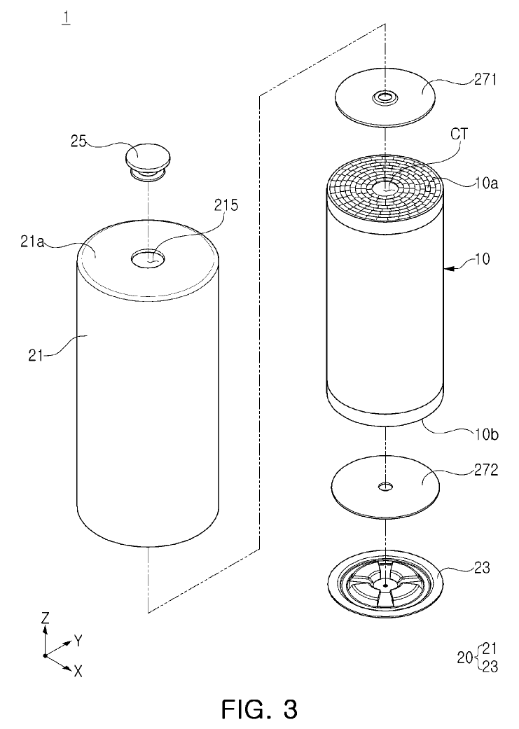

FIG. 2 is a view illustrating a secondary battery according to an embodiment, and FIG. 3 is an exploded view illustrating the secondary battery according to an embodiment.

Referring to FIGS. 2 and 3, a secondary battery 1 may include an electrode assembly 10, a case 20 accommodating the electrode assembly, and an electrode terminal 25 electrically connected to the electrode assembly 10 and exposed outward from the case 20.

The secondary battery 1 including the electrode assembly 10 may be a battery cell. However, the secondary battery 1 is not limited thereto. For example, the secondary battery 1 may be a lithium-ion battery, and the secondary battery 1 is not limited thereto. For example, the secondary battery 1 may be a nickel-cadmium battery, a nickel-metal hydride battery, or a nickel-hydrogen battery rechargeable and dischargeable.

The case 20 may be any one of a pouch type, a prismatic type, or a cylindrical type. For example, as illustrated in the drawings, the secondary battery 1 may be a cylindrical cell in which the case 20 accommodating the electrode assembly 10 has a cylindrical shape, and the secondary battery 1 is not limited thereto. According to an embodiment, the electrode assembly 10 may be wound about a winding axis and accommodated in the case 20. The case 20 may accommodate the electrode assembly 10 therein. The case 20 may include a metal material such as aluminum or stainless steel for electrical rigidity. However, the secondary battery 1 is not limited to the material of the case 20. The case 20 may include a can 21 in which an opening is formed in at least one side thereof and a cap assembly 23 closing the opening of the can.

According to an embodiment, the can 21 may include a terminal hole 215 in which the electrode terminal 25 is disposed at one side and an opening (not shown) in which the cap assembly 23 is disposed at the other side. The terminal hole 215 may be formed in an upper surface 21a of the can. Meanwhile, the term “upper surface” herein does not necessarily indicate a top portion and needs to be interpreted as including one surface of the can 21 in which the opening is not formed. According to an embodiment, a first electrode of the electrode assembly 10 may be electrically connected to the electrode terminal 25, and a second electrode may be electrically connected to at least one of the can 21 or the cap assembly 23. Here, the first electrode may be one of a cathode or an anode, and the second electrode may be an electrode having polarity opposite to the first electrode. According to an embodiment, the cap assembly 23 may be disposed at the opening of the can 21 and may face the electrode terminal 25 with the electrode assembly 10 interposed therebetween.

In addition, the secondary battery 1 may further include current collecting plates 271 and 272 electrically connected to the electrode assembly 10. Each of the current collecting plates 271 and 272 may include an electrically conductive material such as metal. The current collecting plates 271 and 272 may be electrically connected to the electrode assembly 10. According to an embodiment, each of the current collecting plates 271 and 272 may include the first current collecting plate 271 facing one surface 10a of the electrode assembly 10 and the second current collecting plate 272 facing the other surface 10b of the electrode assembly 10.

According to an embodiment, the first current collecting plate 271 may be in contact with and electrically connected to the one surface 10a of the electrode assembly 10. Specifically, the first current collecting plate 271 may be welded by a method such as laser while being in contact with the one surface 10a. Similarly, the second current collecting plate 272 may be in contact with and electrically connected to the other surface 10b of the electrode assembly 10.

The electrode terminal 25 may be disposed in the terminal hole 215 of the can 21. The electrode terminal 25 may include an electrically conductive material and may be electrically connected to an external power source. According to an embodiment, the electrode terminal 25 may be electrically connected to the first current collecting plate 271.

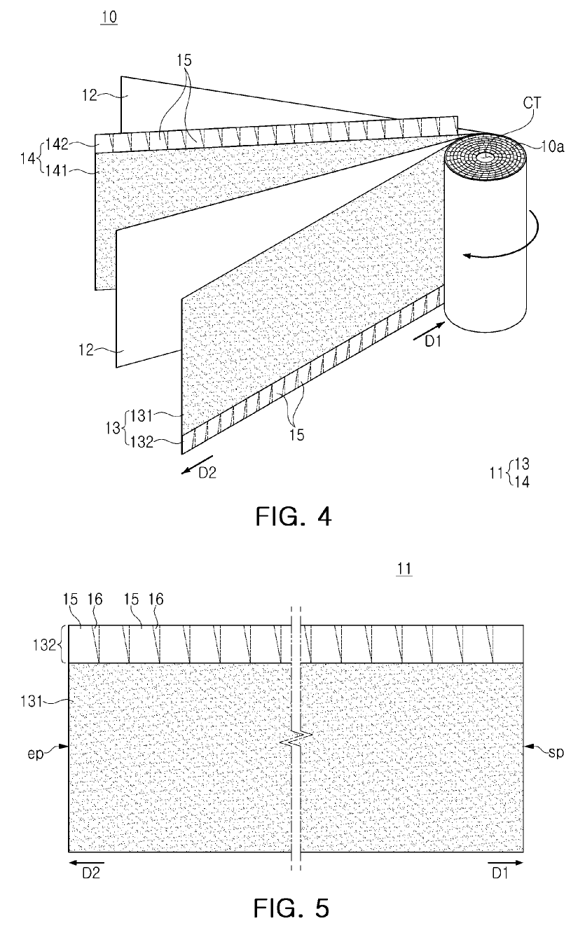

FIG. 4 is a view schematically illustrating the electrode assembly according to an embodiment.

Referring to FIG. 4, the electrode assembly 10 may include a plurality of electrode plates 11 and a separator 12 disposed between the plurality of electrode plates 11. According to an embodiment, the plurality of electrode plates 11 may be provided as a jelly-roll shape wound about the winding axis. According to an embodiment, the electrode assembly 10 may be wound and accommodated in the can 21 while a first electrode plate 13, the separator 12, a second electrode plate 14, and the separator 12 described below are alternately stacked.

The electrode plate 11 may include the first electrode plate 13 having a first polarity and the second electrode plate 14 having a second polarity. According to an embodiment, one of the first electrode plate 13 or the second electrode plate 14 may have a cathode polarity and the other of the first electrode plate 13 or the second electrode plate 14 may have an anode polarity.

According to the present disclosure, the first electrode plate 13 and the second electrode plate 14 may be stacked with wide surfaces facing each other, and the separator 12 may be interposed therebetween. The separator 12 may be disposed between the first electrode plate 13 and the second electrode plate 14 to prevent an electrical short circuit and to allow a flow of ions. For example, the separator 12 may include a porous polymer film or a porous nonwoven fabric.

The first electrode plate 13 may include a first electrode current collector, and a first electrode active material may be coated on the first electrode current collector. According to an embodiment, the first electrode plate 13 may include a first coating portion 131 in which the first electrode active material is coated on the first electrode current collector and a first non-coated region 132 in which the first electrode active material is not coated on the first electrode current collector. The first non-coated region 132 may be a portion in which the first electrode active material is not coated and may be a portion in which the first electrode current collector is exposed. The first non-coated region 132 may function as a passage electrically connected to an adjacent member. The second electrode plate 14 may include a second electrode current collector, and a second electrode active material may be coated on the second electrode current collector. According to an embodiment, the second electrode plate 14 may include a second coating portion 141 in which the second electrode active material is coated on the second electrode current collector and a second non-coated region 142 in which the second electrode active material is not coated on the second electrode current collector. The second non-coated region 142 may be a portion in which the second electrode active material is not coated on the second electrode current collector and may be a portion in which the second electrode current collector is exposed. The second non-coated region 142 may function as a passage electrically connected to an adjacent member.

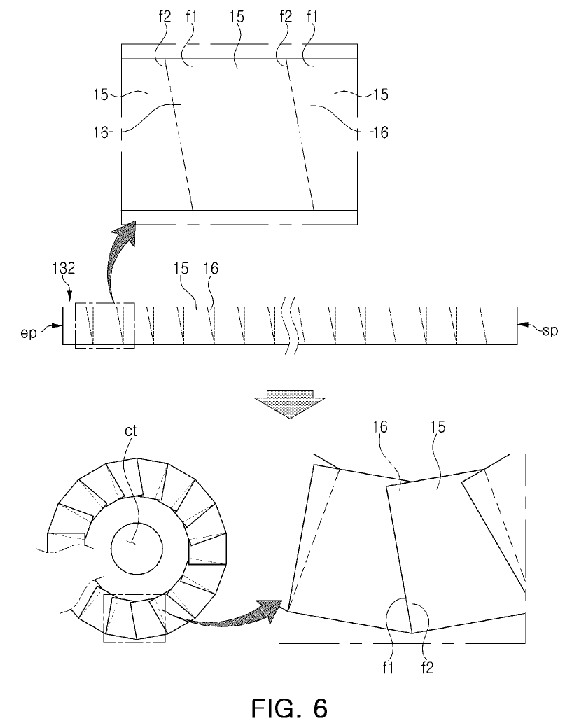

In addition, the electrode assembly 10 according to an embodiment may include a plurality of connection portions 15 formed in at least one of the first non-coated region 132 or the second non-coated region 142 and a folding portion 16 (see FIG. 5) formed between the plurality of connection portions 15. The plurality of connection portions 15 may provide an electrical connection passage electrically connected to at least one of the current collecting plates 271 and 272 or the case 20. The folding portion 16 may be formed by folding lines f1 and f2 (see FIG. 6).

According to an embodiment, the plurality of connection portions 15 and the folding portion 16 may be folded along the folding lines f1 and f2 in a winding direction (wd) (circumferential direction), and the plurality of connection portions 15 may be bent in a direction toward a center (CT) (radial direction) to form at least one of one surface 10a or the other surface 10b of the electrode assembly 10. One surface 10a of the electrode assembly 10 may be electrically connected to the first current collecting plate 271, and the other surface 10b may be electrically connected to the second current collecting plate 272.

As described above, the plurality of connection portions 15 may be formed along the folding lines f1 and f2, and therefore a separate notching process may not be required for the non-coated regions 132 and 142. Accordingly, occurrence of particles during formation of the non-coated regions 132 and 142 may be prevented and the electrode assembly 10 may be manufactured simply and rapidly.

Hereinafter, a structure of the folding portion 16 formed by the plurality of connection portions 15 and the folding lines f1 and f2 is described in detail with reference to the drawings.

FIG. 5 is a view schematically illustrating the electrode plate according to an embodiment, and FIG. 6 is a view illustrating the non-coated region illustrated in FIG. 5. FIG. 6 schematically illustrates only the non-coated region 132 illustrated in FIG. 5. Although FIGS. 5 and 6 are illustrated based on the first electrode plate 13 for convenience of description, the same may be applied to the non-coated region 142 of the second electrode plate 14.

Referring to FIG. 5, the electrode assembly 10 according to an embodiment may include the first electrode plate 13 wound in the winding direction (wd) and including the first non-coated region 132 in which the first electrode active material is not coated, a second electrode plate 14 wound in the winding direction (wd) and including the second non-coated region 142 in which the second electrode active material is not coated, and a separator 12 disposed between the first electrode plate 13 and the second electrode plate 14, and at least one of the first non-coated region 132 or the second non-coated region 142 may include the plurality of connection portions 15 folded along the folding lines f1 and f2. Hereinafter, the present disclosure is described in detail.

An end of the electrode plate 11 in an inner direction D1 may be referred to as a starting portion (sp), and an end of the electrode plate 11 in an outer direction D2 may be referred to as an ending portion (ep). Although the drawings describe the first electrode plate 13 as a reference, the starting portion (sp) and the ending portion (ep) are terms for describing relative positions with respect to the winding axis. Such terms are not limited to the first electrode plate 13 and may be used for any structure of the electrode assembly 10. In addition, the plurality of connection portions 15 may be formed in the non-coated region 132 along a direction from the inner circumference toward the outer circumference of the electrode plate 11, and the folding portion 16 may be disposed between the plurality of connection portions 15. As described above, the plurality of connection portions 15 may be folded in the direction toward the center (CT) (radial direction) to form at least one of one surface 10a or the other surface 10b of the electrode assembly 10.

Referring to FIG. 6, the folding portion 16 may be formed by the folding lines f1 and f2. The folding lines f1 and f2 may provide reference lines along which the non-coated regions 132 and 142 are folded. The non-coated regions 132 and 142 of the electrode assembly 10 may be folded along the folding lines f1 and f2 in the winding direction (wd) to form the plurality of connection portions 15 and the folding portion 16 disposed therebetween. The plurality of connection portions 15 may be folded with the folding portion 16 interposed therebetween. That is, the plurality of connection portions 15 may be folded toward each other along the folding lines f1 and f2. According to an embodiment, the plurality of connection portions 15 may have a trapezoidal shape due to the folding portion 16. That is, the folding lines f1 and f2 may allow the plurality of connection portions 15 to be folded into the trapezoidal shape, and may form the folding portion 16 disposed between the plurality of connection portions 15.

As illustrated in the drawings, the folding lines f1 and f2 may include the first folding line f1 and the second folding line f2 having a predetermined angle therebetween. The first folding line f1 and the second folding line f2 may form the folding portion 16 disposed between the plurality of connection portions 15. The plurality of connection portions 15 may be folded in directions opposite to each other at the first folding line f1 and the second folding line f2. In other words, the plurality of connection portions 15 may be folded toward one side based on the first folding line f1 and toward the other side based on the second folding line f2.

Referring to enlarged views of upper and lower portions of FIG. 6, the connection portions 15 may be folded outward from the first folding line f1 and inward from the second folding line f2. The folding portion 16 may be disposed between the plurality of connection portions 15. The folding portion 16 may be interposed between the plurality of connection portions 15 and may overlap the plurality of connection portions 15 in a height direction. In other words, the folding portion 16 may be foldable to overlap at least one of the plurality of connection portions 15. That is, the folding portion 16 may not be exposed outward while the connection portions 15 are covered. The plurality of connection portions 15 may be folded along the circumferential direction (or the winding direction (wd)) while being folded together with the folding portion 16. Accordingly, an area corresponding to the folding portion 16 may overlap between adjacent ones of the plurality of connection portions 15. That is, the plurality of connection portions 15 may be folded to overlap at least a portion thereof in the winding direction (wd) (or the circumferential direction).

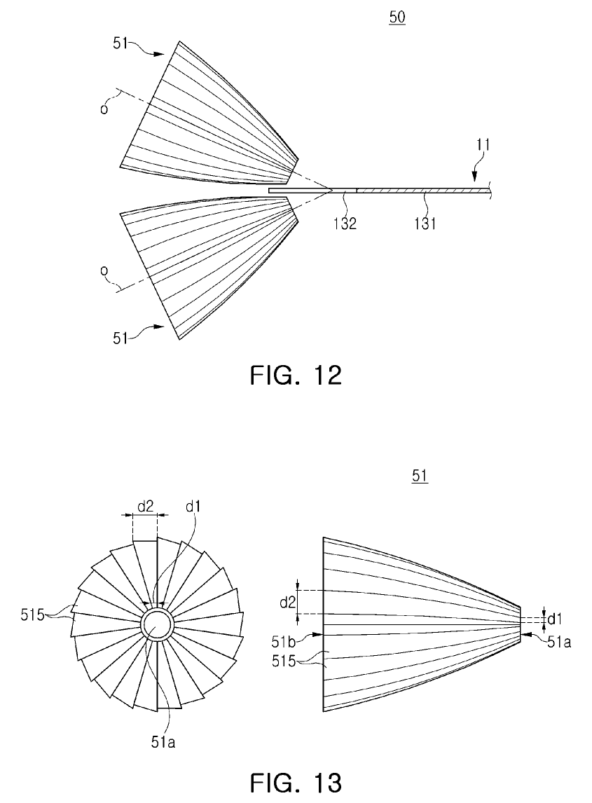

Meanwhile, the folding lines f1 and f2 may indicate lines serving as references along which the folding portion 16 is folded, and may indicate lines formed while the non-coated regions 132 and 142 are temporarily folded by folding rollers 51, as described below with reference to FIG. 12. However, the folding lines f1 and f2 are not limited thereto as long as the folding lines f1 and f2 indicate reference lines along which the folding portion 16 is folded, and may be a kind of virtual lines.

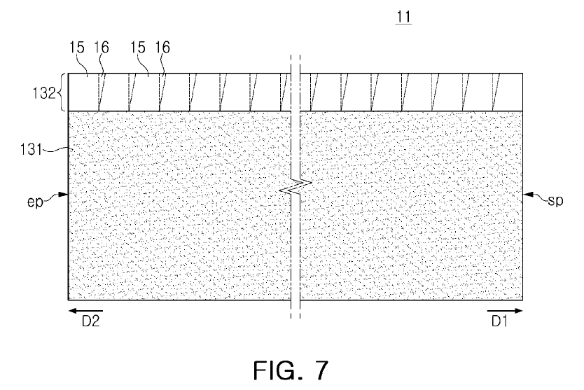

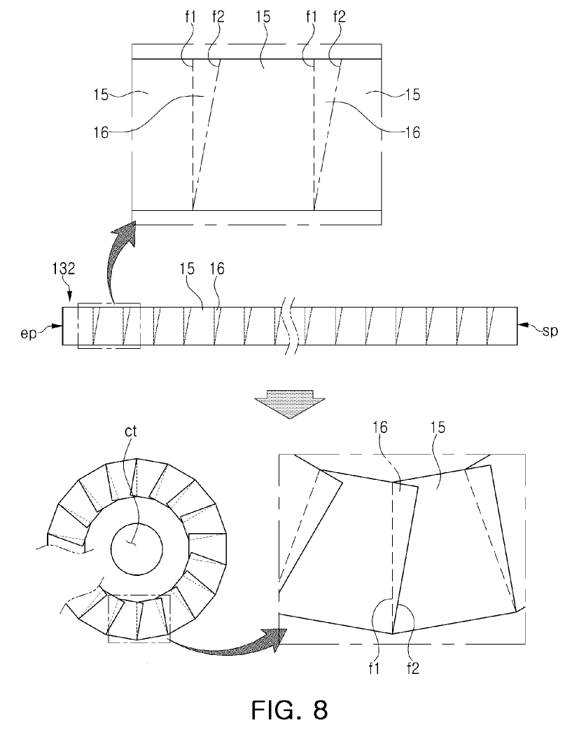

FIG. 7 is a view schematically illustrating the electrode plate according to another embodiment, and FIG. 8 is a view illustrating the non-coated region illustrated in FIG. 7. FIG. 8 schematically illustrates only the non-coated region 132 illustrated in FIG. 7. FIGS. 7 and 8 are illustrated based on the first electrode plate 13 for convenience of description, and the same may be similarly applied to the non-coated region 142 of the second electrode plate 14. In addition, descriptions overlapping those described above with reference to FIGS. 5 and 6 are omitted.

Referring to FIGS. 7 and 8 together, in another embodiment, compared with an embodiment described above with reference to FIGS. 5 and 6, the second folding line f2 may be inclined toward the starting portion (sp). In addition, referring to enlarged views of upper and lower portions of FIG. 8, the connection portions 15 may be folded inward from the first folding line f1 and outward from the second folding line f2.

As described above, the electrode assembly is not limited to an angle between the folding lines f1 and f2 or a folding direction, and all structures in which the non-coated regions 132 and 142 are folded by the folding portion 16 to form the plurality of connection portions 15 may belong thereto.

Hereinafter, various embodiments according to structures of the connection portions 15 and the folding portion 16 are described, and descriptions overlapping those described above are omitted.

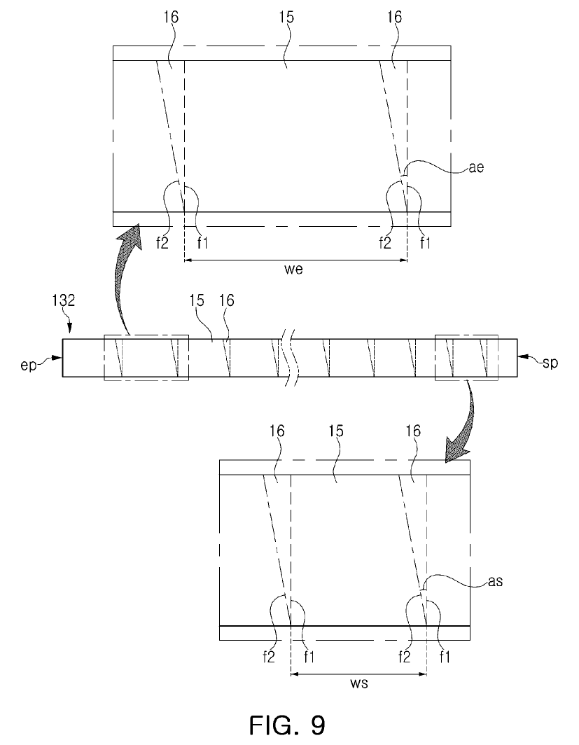

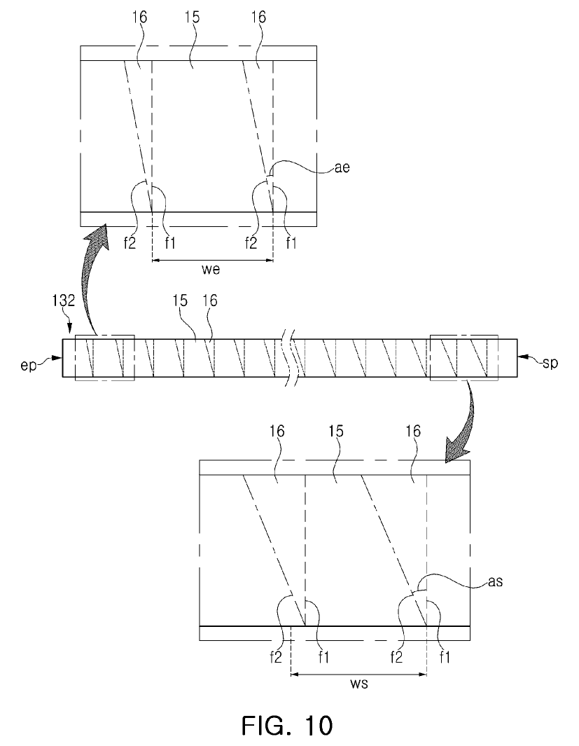

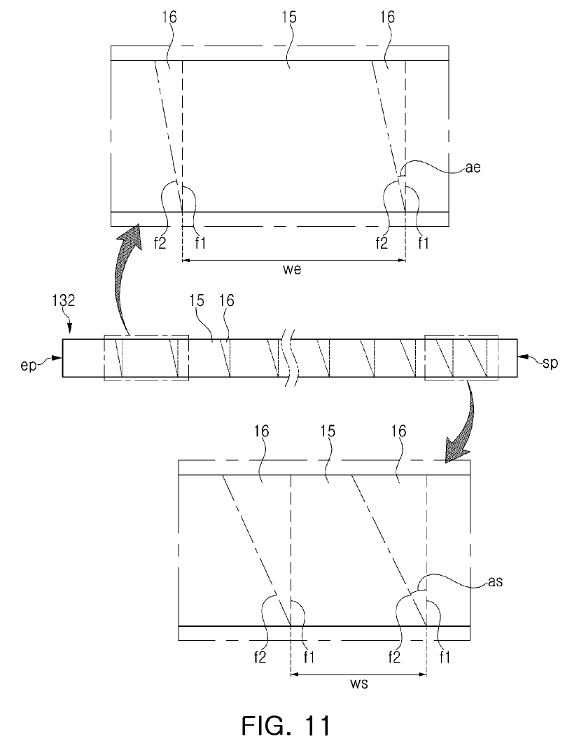

FIG. 9 is a view illustrating a first embodiment of the non-coated region, FIG. 10 is a view illustrating a second embodiment of the non-coated region, and FIG. 11 is a view illustrating a third embodiment of the non-coated region. FIGS. 9 through 11 are described based on the first non-coated region 132 of the first electrode plate 13. However, description of the first embodiment based on the first non-coated region 132 is not limited thereto, and may be similarly applied to the second non-coated region 142 of the second electrode plate 14.

Referring to FIG. 9, according to the first embodiment, the connection portions 15 may allow a width of each of the connection portions 15 to increase from the starting portion (sp) toward the ending portion (ep) of each of the non-coated regions 132 and 142. Here, the width of each of the connection portions 15 may indicate a size of at least one of an upper side or a lower side of each of the connection portions 15. Specifically, among the plurality of connection portions 15, a width (we) of an arbitrary connection portion 15 disposed relatively closer to the ending portion (ep) may be greater than a width (ws) of an arbitrary connection portion 15 disposed relatively closer to the starting portion (sp). In contrast, an angle (as or ae) between the first folding line f1 and the second folding line f2 (folding angle) may not substantially change from the starting portion (sp) toward the ending portion (ep).

That is, according to the first embodiment, the plurality of connection portions 15 may be disposed to increase the width thereof from the starting portion (sp) toward the ending portion (ep). In addition, according to the first embodiment, a base angle (as or ae) of the folding portion 16 disposed between the plurality of connection portions 15 may be constant from the starting portion (sp) toward the ending portion (ep).

Referring to FIG. 10, according to the second embodiment, the non-coated regions 132 and 142 may have the base angle of the folding portion 16 (an angle between the first folding line f1 and the second folding line f2) that decreases from the starting portion (sp) toward the ending portion (ep). Specifically, among the plurality of folding portions 16, the angle (ae) of the folding portion 16 disposed relatively closer to the ending portion (ep) may be smaller than the angle (as) of the folding portion 16 disposed relatively closer to the starting portion (sp). Accordingly, the base angle between the connection portions 15 may increase toward the ending portion (ep). In contrast, each of the connection portions 15 may have a constant width from the starting portion (sp) toward the ending portion (ep).

That is, according to the second embodiment, the connection portions 15 may have the base angle between the connection portions 15 increasing from the starting portion (sp) toward the ending portion (ep). In other words, the base angle (as or ae) of the folding portion 16 disposed between the plurality of connection portions may decrease from the starting portion (sp) toward the ending portion (ep).

Referring to FIG. 11, according to the third embodiment, the non-coated regions 132 and 142 may allow the width of the connection portions 15 to increase and the base angle of the folding portion 16 to decrease from the starting portion (sp) toward the ending portion (ep). Specifically, among the plurality of connection portions 15, the width (we) of an arbitrary connection portion 15 disposed closer to the ending portion (ep) may be greater than the width (ws) of an arbitrary connection portion 15 disposed relatively closer to the starting portion (sp), and among the plurality of folding portions 16, the angle (ae) of the folding portion 16 disposed relatively closer to the ending portion (ep) may be smaller than the angle (as) of the folding portion 16 disposed relatively closer to the starting portion (sp).

That is, according to the third embodiment, a width and a base angle of each of the connection portions 15 may increase from the starting portion (sp) toward the ending portion (ep). In other words, according to the third embodiment, the base angle (as or ae) of the folding portion 16 disposed between the plurality of connection portions 15 may decrease from the starting portion (sp) toward the ending portion (ep). In addition, according to the third embodiment, the width of each of the plurality of connection portions 15 may increase toward the ending portion (ep).

However, the electrode assembly is not limited to the first through third embodiments described above, and may have the width of each of the connection portions 15 decreasing and/or the base angle decreasing toward the ending portion (ep).

The present disclosure may include any structure in which at least one of the first non-coated region 132 and the second non-coated region 142 is folded by the folding lines f1 and f2 or in which the plurality of connection portions 15 and the folding portion 16 are folded together.

Hereinafter, a manufacturing apparatus and a manufacturing method for a secondary battery according to an embodiment are described.

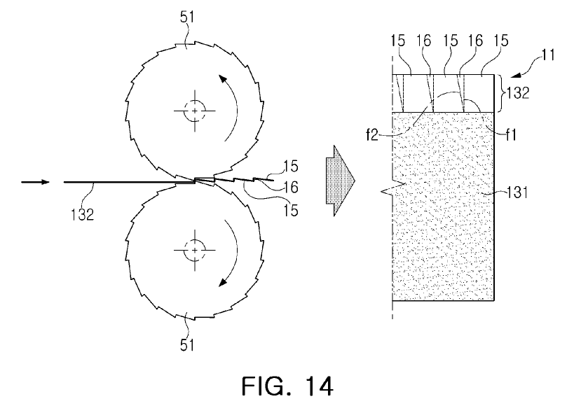

FIG. 12 is a schematic view illustrating a manufacturing apparatus according to an embodiment, FIG. 13 is a view illustrating the roller portion according to an embodiment, and FIG. 14 is a view illustrating a manufacturing process using the roller portion.

Referring to FIG. 12, a manufacturing apparatus 50 for a secondary battery according to an embodiment may include folding rollers 51.

The manufacturing apparatus for a secondary battery according to an embodiment may include a pair of folding rollers 51 facing each other with the electrode plate 11 interposed therebetween and rotating about a rotation axis (o), and the pair of folding rollers 51 may include a plurality of teeth portions 515 formed on an outer circumferential surface and may form the folding lines f1 and f2 to allow the non-coated regions 132 and 142 of the electrode plate 11 to be folded while rotating with the electrode plate 11 interposed therebetween.

The pair of folding rollers 51 may face each other with the non-coated regions 132 and 142 interposed therebetween. The pair of folding rollers 51 may face the electrode plate 11 and may form the folding lines f1 and f2 in the non-coated regions 132 and 142 while rotating about the rotation axis (o) (see FIG. 14), respectively. Meanwhile, the rotation axis (o) herein may be a virtual axis about which the folding rollers 51 rotate, and the manufacturing apparatus for a secondary battery is not limited thereto.

Referring to FIG. 13, the folding rollers 51 may have a thickness of the other side 51b greater than a thickness of one side 51a. In addition, the folding roller 51 may include the plurality of teeth portions 515 disposed along the outer circumferential surface. The folding rollers 51 may form the folding lines f1 and f2 using the plurality of teeth portions 515. In addition, according to an embodiment, the teeth portions 515 may have a thickness d2 of the other side greater than a thickness d1 of one side of each of the teeth portions 515.

Referring to FIG. 14, the pair of folding rollers 51 may form the folding lines f1 and f2 in the non-coated regions 132 and 142 while facing one electrode plate 11 and rotating in directions opposite to each other. More specifically, the teeth portions 515 of the pair of folding rollers 51 facing each other may rotate while being disposed alternately from each other and may press the non-coated regions 132 and 142 disposed therebetween to form the folding lines f1 and f2. Here, the folding lines f1 and f2 may be folding marks formed by the teeth portions 515 and may function as guides for facilitating folding of the connection portions 15 and the folding portion 16 together.

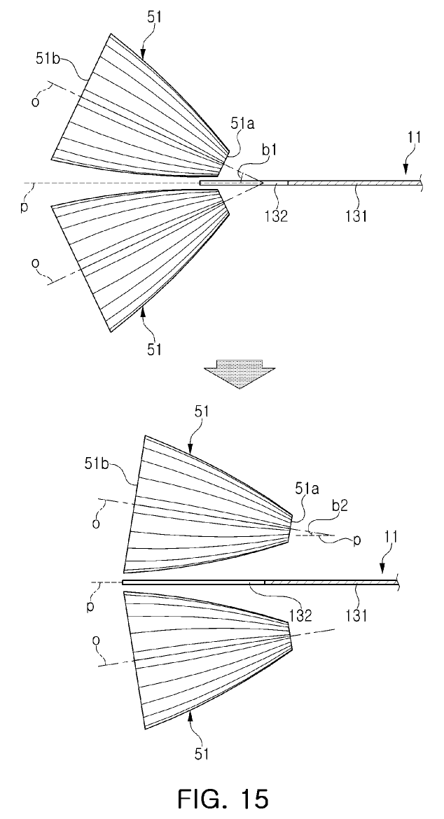

FIG. 15 is a view illustrating an operation example of the roller portion.

According to an embodiment, the pair of folding rollers 51 may operate to change an angle of the rotation axis (o) from a start of rotation to an end of rotation. Accordingly, the width of each of the plurality of connection portions 15 or the angle between the plurality of connection portions 15 formed in the electrode plate 11 may increase or decrease toward the ending portion (ep). Specifically, the pair of folding rollers 51 may be disposed to allow the rotation axis (o) to form predetermined angles b1 and b2 with respect to a horizontal line (p) of the electrode plate 11, and the pair of folding rollers 51 may include the rotation axis (o) having a changeable angle to change the predetermined angles b1 and b2.

For example, referring to FIG. 9 together, the manufacturing apparatus 50 for a secondary battery may manufacture the electrode assembly 10 in which the width of the connection portions 15 increases from the starting portion (sp) toward the ending portion (ep). Specifically, while the rotation axis (o) of the folding rollers 51 and the horizontal line (p) of the electrode plate 11 form the first angle b1 at the starting portion (sp) (a rotation start side), the folding rollers 51 may rotate to form the connection portions 15 each having the predetermined width (ws) (see FIG. 9). In addition, while the rotation axis (o) of the folding rollers 51 and the horizontal line (p) of the electrode plate 11 form the second angle b2 at the ending portion (ep) (a rotation end side), the folding rollers 51 may rotate to form the connection portions 15 each having the predetermined width (we) (see FIG. 9). Here, as described above with reference to FIG. 13, the thickness d2 of the other side of the teeth portions 515 may be greater than the thickness d1 of one side of the teeth portions 515, and the width of each of the connection portions 15 formed by the teeth portions 515 may thus also gradually increase.

That is, according to an embodiment, the rotation axis (o) of the folding rollers 51 may be changed to change the angles b1 and b2 between the rotation axis (o) and the electrode plate 11 from the starting portion (sp) toward the ending portion (ep). Accordingly, the width, angle, or the like of the plurality of connection portions 15 may be adjusted.

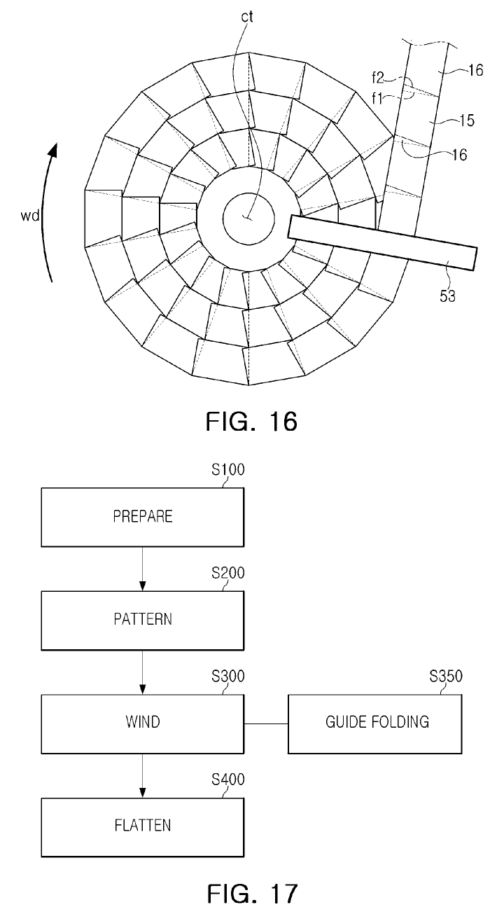

FIG. 16 is a view illustrating a manufacturing process using the folding guide.

The manufacturing apparatus for a secondary battery according to an embodiment may further include a folding guide 53 guiding the non-coated regions 132 and 142 to be folded along the folding lines f1 and f2. Specifically, in a manufacturing process of the electrode assembly 10, the electrode plate 11 may be wound in the winding direction (wd), and the folding guide 53 may fold at least a portion of the connection portions 15 toward the center (CT) to have the plurality of connection portions 15 and the folding portion 16 properly folded along the folding lines f1 and f2. In other words, the folding guide 53 may guide the non-coated regions 132 and 142 to be folded in the direction toward the center (CT) during winding of the electrode assembly 10 to have the connection portions 15 properly folded along the folding lines f1 and f2. Accordingly, the connection portions 15 and the folding portion 16 may be folded toward predetermined directions, and defects may be reduced.

FIG. 17 is a flowchart illustrating a manufacturing method according to an embodiment. Descriptions overlapping those described above with reference to FIGS. 1 through 16 are omitted.

The manufacturing method for a secondary battery according to an embodiment may further include preparing (S100), patterning (S200), and winding (S300).

The preparing (S100) may include preparing the electrode plate 11 including the non-coated regions 132 and 142. A description of the electrode plate 11 is provided above and is thus omitted.

The patterning (S200) may include forming the folding lines f1 and f2. Specifically, the patterning (S200) may include forming the folding lines f1 and f2 in the non-coated regions 132 and 142 of the electrode plate 11 using the folding rollers 51 (see FIG. 14). In addition, the patterning (S200) may further include angle changing for changing an angle of the rotation axis (o) of the folding rollers 51 (see FIG. 15). Specifically, the angle changing may change the angle of the rotation axis (o) to change the angles b1 and b2 between the rotation axis (o) of the folding rollers 51 and the horizontal line (p) of the electrode plate 11. A description thereof is provided above with reference to FIG. 15, and is thus omitted.

The winding (S300) may include winding the electrode assembly 10 including the electrode plate 11 in the winding direction (wd). The winding (S300) may further include guiding(S350) the plurality of connection portions 15 and the folding portion 16 to be folded along the folding lines f1 and f2 using the folding guide 53.

In addition, the manufacturing method for a secondary battery according to an embodiment may further include flattening (S400) of pressing the non-coated regions 132 and 142 toward the center (CT) after the winding (S300) to form at least one of one surface 10a or the other surface 10b of the electrode assembly 10.

In addition, according to an embodiment, the manufacturing method for a secondary battery may include the preparing (S100) of preparing the electrode plate 11 including the non-coated regions 132 and 142, the patterning (S200) of forming the folding lines f1 and f2 in the non-coated regions 132 and 142, and the winding (S300) of winding the electrode plate 11 in the winding direction (wd), and the winding (S300) may further include the guiding (S350) the non-coated regions 132 and 142 to be folded along the folding lines f1 and f2.

An embodiment of the present disclosure may provide the electrode assembly, in which a flag is formed without notching the non-coated region, and the manufacturing apparatus and method for the same.

An embodiment of the present disclosure may provide the electrode assembly having improved quality, and the manufacturing apparatus and method for the same.

An embodiment of the present disclosure may provide the electrode assembly having a reduced manufacturing cost and the manufacturing apparatus and method for the same.

Only specific examples of implementations of certain embodiments are described. Variations, improvements and enhancements of the disclosed embodiments and other embodiments may be made based on the disclosure of this patent document.

What is claimed is:

1. An electrode assembly comprising:
a first electrode plate wound in a winding direction and including a first non-coated region in which a first electrode active material is not coated;
a second electrode plate wound in the winding direction and including a second non-coated region in which a second electrode active material is not coated; and
a separator disposed between the first electrode plate and the second electrode plate,
wherein at least one of the first non-coated region or the second non-coated region includes a plurality of connection portions folded along folding lines.

2. The electrode assembly of claim 1, wherein the folding lines allow the plurality of connection portions to be folded into a trapezoidal shape and form a folding portion disposed between the plurality of connection portions.

3. The electrode assembly of claim 1, wherein the folding lines include a first folding line and a second folding line having a predetermined angle therebetween, and
the first folding line and the second folding line form a folding portion disposed between the plurality of connection portions.

4. The electrode assembly of claim 2, wherein the plurality of connection portions are folded to overlap at least a portion thereof in the winding direction.

5. The electrode assembly of claim 1, wherein the folding lines include a first folding line and a second folding line, and
the plurality of connection portions are folded in directions opposite to each other at the first folding line and the second folding line.

6. The electrode assembly of claim 5, wherein the plurality of connection portions are folded toward one side based on the first folding line and toward the other side based on the second folding line.

7. The electrode assembly of claim 4, wherein each of the plurality of connection portions has a width that increases from a starting portion toward an ending portion.

8. The electrode assembly of claim 7, wherein a base angle of the folding portion disposed between the plurality of connection portions is constant from the starting portion toward the ending portion.

9. The electrode assembly of claim 4, wherein each of the plurality of connection portions has a constant width from a starting portion toward an ending portion.

10. The electrode assembly of claim 9, wherein a base angle of the folding portion disposed between the plurality of connection portions decreases from the starting portion toward the ending portion.

11. The electrode assembly of claim 7, wherein a base angle of the folding portion disposed between the plurality of connection portions decreases from the starting portion toward the ending portion.

12. A manufacturing apparatus for a secondary battery, the manufacturing apparatus comprising:
a pair of folding rollers facing each other with an electrode plate interposed therebetween and rotating about a rotation axis,
wherein the pair of folding rollers include a plurality of teeth portions formed on an outer circumferential surface and form folding lines to allow a non-coated region of the electrode plate to be folded while rotating with the electrode plate interposed therebetween.

13. The manufacturing apparatus of claim 12, wherein the folding rollers are disposed to allow the rotation axis to form predetermined angles with respect to a horizontal line of the electrode plate, and
the folding rollers include the rotation axis having a changeable angle to change the predetermined angles.

14. The manufacturing apparatus of claim 12, further comprising a folding guide guiding the non-coated regions to be folded along the folding lines.

15. A manufacturing method for a secondary battery, the manufacturing method comprising:
preparing an electrode plate including non-coated regions;
patterning the non-coated regions to form folding lines; and
winding the electrode plate in a winding direction,
wherein the winding further includes
guiding the non-coated regions to be folded along the folding lines.
